(19) United States
(12) Patent Application Publication
(10) Pub. No.: US 2025/0256771 A1
(43) Pub. Date: Aug. 14, 2025

(54) METHOD TO CONTROL A STEER-BY-WIRE STEERING SYSTEM OF A ROAD VEHICLE WITH VIRTUAL END STOP FEEDBACK FUNCTIONS

(71) Applicants: Thyssenkrupp Presta AG, Eschen (LI); HONDA MOTOR CO., LTD., Tokyo (JP)

(72) Inventors: Munetsugu HANJI, Wako-shi (JP); Imre SZEPESSY, Mauren (LI); Yoshinobu WATANABE, Wako-shi (JP); Zoltán SZANDER, Tárnok (HU); Levente PÁSZTOR, Budapest (HU)

(21) Appl. No.: 19/194,388

(22) Filed: Apr. 30, 2025

Related U.S. Application Data
(63) Continuation of application No. PCT/EP2022/082112, filed on Nov. 16, 2022.

(51) Int. Cl. B62D 6/00

(52) U.S. Cl. CPC B62D 6/008

(57) ABSTRACT

A method to control a steer-by-wire steering system for a road vehicle includes providing a basic feedback torque when steering toward a mechanical end stop and a steering wheel angle is greater than or equal to an activation steering position, activating a first virtual end stop feedback function to determine a counter torque counteracting a driver's operation of the steering wheel, the first virtual end stop feedback function depending on the steering wheel angle and a steering speed, adding the counter torque to the basic feedback torque to yield a steering wheel torque, a course of the first virtual end stop feedback function being such that at a virtual steering end stop position a predefined maximum steering wheel torque is reached, and sending a resulting steering wheel torque to a feedback actuator and controlling the feedback actuator accordingly.

### CROSS REFERENCE TO RELATED APPLICATIONS

This application claims the benefit of priority to Continuation Application of PCT Application No. PCT/EP2022/082112 filed on Nov. 16, 2022. The entire contents of this application are hereby incorporated herein by reference.

### BACKGROUND OF THE INVENTION

### 1. Field of the Invention

The present invention relates to methods to control steer-by-wire steering systems of road vehicles and to steer-by-wire steering systems for road vehicles.

### 2. Description of the Related Art

In a steer-by-wire steering system, the vehicle's steering wheel is disengaged from the steering mechanism. In such a steering system, there is no mechanical coupling between the steering wheel and the steering gear. Steering movement is achieved by a steering actuator with an electric motor. The steering actuator operates in response to detected values of various steering parameters, such as steering wheel angle and vehicle speed, etc. The detected values are communicated electronically to the steering actuator from sensors, whereby the electric motor drives the rack and orients the steerable wheels in the desired direction.

Even though the mechanical linkage between the steering wheel and the road wheels has been eliminated, a steer-by-wire steering system is expected to produce the same functions and steering feel as a conventional mechanically linked steering system.

In steer-by-wire steering systems, the steering wheel can rotate freely without limits. However, safe operation requires defined steering end stop positions because of drivability, controllability and other mechanical constraints, e.g., wires connected to the steering wheel switches, and so on. An adjustable mechanical steering wheel range limiter to solve the problem would require high complexity and cost.

From EP 3 315 383 B1 it is known to implement a virtual steering limit position. In the case where the steering wheel has been operated by the driver to a threshold close to a desired steering angle value determined as a virtual steering end stop position, a first correction value calculation circuit calculates a first correction value so that a force that resists the driver's operation of the steering wheel is increased, and a base command value is corrected with the first correction value. This makes it difficult for the driver to further operate the steering wheel to a position beyond the virtual steering end stop position when the position of the steering wheel becomes close to the virtual steering end stop position. The driver's operation of the steering wheel can thus be virtually stopped near the virtual steering end stop position.

### SUMMARY OF THE INVENTION

Example embodiments of the present invention provide methods for steer-by-wire steering systems of road vehicles that provide a natural steering feel close to a mechanical end stop position.

An example embodiment of the present invention provides a method to control a steer-by-wire steering system for a road vehicle. The steer-by-wire steering system includes a steering wheel, a road wheel actuator to actuate road wheels, and a feedback actuator with mechanical end stops to apply a feedback torque to the steering wheel and a sensor to detect a steering wheel angle and a steering speed of the steering wheel. The method includes providing a basic feedback torque, when steering toward a mechanical end stop and the steering wheel angle is greater than or equal to an activation steering position: activating a first virtual end stop feedback function, which determines a counter torque counteracting a driver's operation of the steering wheel, the first virtual end stop feedback function depending on the steering wheel angle and the steering speed, adding the counter torque to the basic feedback torque to yield a steering wheel torque, a course of the first virtual end stop feedback function being such that at a virtual steering end stop position a predefined maximum steering wheel torque is reached, and sending a resulting steering wheel torque to the feedback actuator and controlling the feedback actuator accordingly, when steering backward from a mechanical end stop and the steering wheel angle is greater than or equal to a deactivation steering position: activating a second virtual end stop feedback function to determine a counter torque counteracting a driver's operation of the steering wheel, the second virtual end stop feedback function depending on the steering wheel angle and the steering speed, adding the counter torque to the basic feedback torque to yield a steering wheel torque, a course of the second virtual end stop feedback function being such that at a virtual steering end stop position the predefined maximum steering wheel torque is reached, and sending a resulting steering wheel torque to the feedback actuator and controlling the feedback actuator accordingly.

It is to be understood that this is preferred for both mechanical end stops. The virtual end stop feedback functions provide a more natural end stop feel than with mechanical end stops only. Another purpose of this function is to make the driver aware of reaching the mechanical end stop. In addition, this function can reduce the contact of the mechanical end stop by increasing the counter-torque. The first and second virtual end stop feedback function are preferably different for the same steering speed and create a hysteresis.

Preferably, the first and second virtual end stop feedback functions are based on look-up tables.

It is advantageous if the counter torque provided by the first virtual end stop feedback function increases with increasing steering wheel angle.

Preferably, the virtual end stop feedback functions are steering speed dependent, such that, when the respective virtual end stop feedback function is activated, the steering speed modification is determined by the current steering speed. This ensures that no torque fluctuation due to steering speed changes occur while the virtual end stop feedback function is active.

Preferably, the virtual steering end stop position is at a smaller steering wheel angle for higher steering speeds compared to lower steering speeds.

To prevent reaching the mechanical end stop position, the virtual steering end stop position preferably is less than or equal to the mechanical end stop position.

Preferably, the virtual end stop feedback functions are modified by a gain factor during parking maneuvers.

Preferably, the virtual steering end stop position is the same for the first and the second virtual end stop feedback function for the same mechanical end stop.

It is advantageous if, in the event of a wheel blocking on a curb, the virtual steering end stop position is at or in a vicinity of the actual steering position, i.e., closer than a virtual steering end stop position under normal conditions.

If the mechanical end stops are different, the first virtual end stop feedback functions preferably have the same absolute activation steering position and the same absolute virtual steering end stop position. At the same steering speed, the functions are symmetrical to the neutral position (i.e., to the left and to the right). This compensates for the deviation of the mechanical end stops between the left side and the right side of the steering system. For example, if the left mechanical end stop is at X degree and the right is at X+d degree, the first virtual end stop feedback functions build up a counter steering torque from the same absolute steering angle (activation steering position). The end stop contact feeling is provided by the first virtual end stop feedback functions and is preferably identical for both sides. If the steering speed is different when steering towards one or the other mechanical end position, the end stop contact feeling may be different. For example, the counter torque can go into saturation at maximum torque of the feedback actuator before the mechanical end stop is reached.

In addition, a steer-by-wire steering system for a road vehicle configured or programmed to perform the method described above is provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic illustration of a steer-by-wire steering system of a motor vehicle.

FIG. 2 shows a diagram of steering wheel torque plotted against steering wheel angle.

### DETAILED DESCRIPTION OF THE EXAMPLE EMBODIMENTS

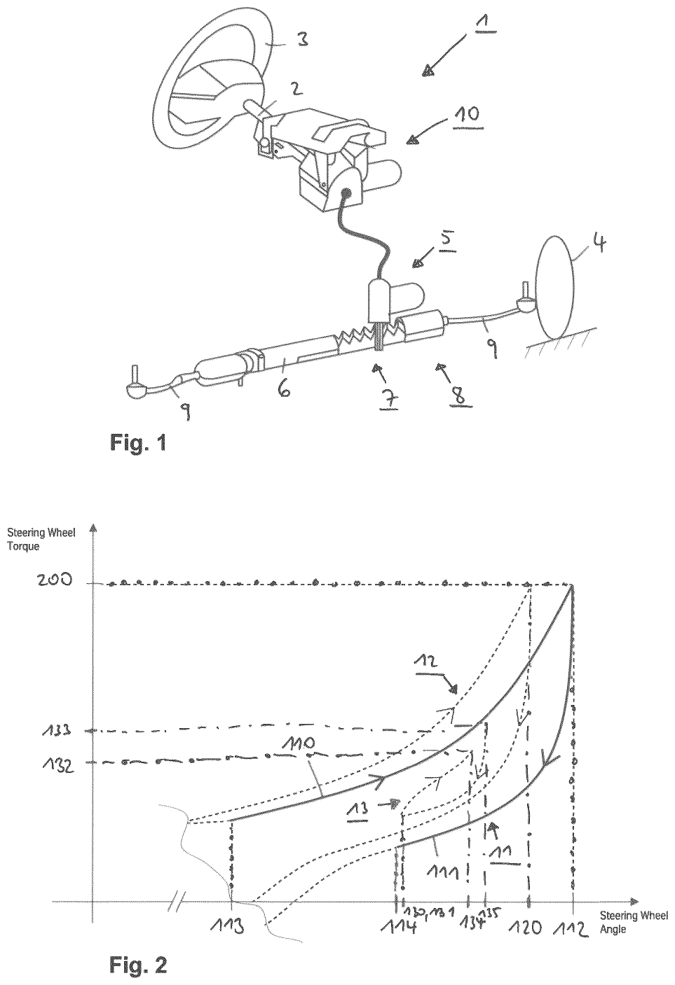

FIG. 1 is a schematic drawing of a steer-by-wire system 1 with a steering shaft 2 connected to a steering wheel 3. There is no mechanical connection between the steering wheel 3 and road wheels 4. A road wheel actuator 5 operates a gear rack 6 via a rack-and-pinion gear 7, which is part of a front wheel axle 8. The front wheel axle 8 includes two tie rods 9 for road wheels 4, of which only one road wheel 4 is shown.

When a driver operates the steering wheel 3, steering shaft 2 is rotated, which is detected by a shaft sensor, which is not shown in the drawings. A controller is configured or programmed to calculate an operation signal for the road wheel actuator 5 from the signal detected by the shaft sensor. By operating gear rack 6 with the operation signal, the front wheel axle 8 is moved sideways and the road wheels 4 are turned. At the same time, forces introduced in the wheel axle 8 from the road wheels 4 are detected by another sensor, not shown in the drawings, and a feedback signal is calculated, which is applied to the steering shaft 2 by a feedback actuator 10, resulting in steering wheel torque so that the operator can recognize the feedback in the steering wheel 3.

FIG. 2 shows a total of three hysteresis curves 11, 12, 13 for steering wheel torque as a function of steering wheel angle.

When steering toward a mechanical end stop from an activation steering position, a virtual end stop feedback function is activated and added to a basic feedback torque resulting in the steering wheel torque plotted on the y-axis. The virtual end stop feedback function determines an additional counter torque. The basic feedback torque is calculated based on a steering wheel angle, a steering speed, wheel vehicle dynamics (e.g. longitudinal, lateral motions of the vehicle, etc.), a rack force and a rack motion. When steering backward from the mechanical end stop, the virtual end stop feedback function is active until a deactivation steering position is reached.

The steering wheel torque has a maximum value, so that the steering wheel angle has a maximum value determined by a mechanical end stop position. The progression of the counter torque as a function of the steering wheel angle is preferably tuned by look-up tables. Steering position breakpoints (predefined steering wheel positions) and counter torque values are defined as value pairs up to the maximum steering wheel torque value and a virtual steering end stop position. The virtual steering end stop position can be defined by the mechanical end stop position, or close to the mechanical end position at a lower value. The steering position breakpoints are tunable parameters. The points between two breakpoints are interpolated.

The course of the steering wheel torque as a function of the steering wheel angle is different when steering toward the virtual steering end stop position than when steering backwards. Two independent virtual end stop feedback functions are used and include one for steering toward the virtual steering end stop position and one for steering backwards. This implements a unique torque hysteresis that achieves a natural feel for the end stops. The activation steering position and deactivation steering position for the virtual end stop feedback function are preferably identical. However, since the feedback characteristic is different, this creates the feeling that the function is deactivated at a different position than it is activated.

A software algorithm calculates the counter torque based on the steering wheel angle and the steering speed of the steering wheel. The virtual end stop feedback functions include each a basic function which is preferably modified by steering speed dependent parameters.

FIG. 2 shows two steering wheel torque hysteresis 11, 12 for two different steering speeds and a steering wheel torque hysteresis 13 for small steering direction changes. The arrows indicate the steering direction. The solid lines 110, 111 represent a basic hysteresis curve 11 for normal steering speeds, preferably up to about 50 degrees, for example. When steering toward the virtual steering end stop position 112, the upper line 110 applies. From an activation position, the counter torque calculated based on a first virtual end stop feedback function is added to the basic feedback torque. The steering process starts from a start steering wheel angle 113. The resulting steering wheel torque increases slowly at first and then rapidly up to the maximum value 200 reached at the virtual steering end stop position 112. The counter torque counteracts the driver's operation and the steering feel is comparable to conventional electromechanical steering systems with a mechanical end stop. When steering backward from the virtual steering end stop position 112, the lower line 111 and a second virtual end stop feedback function applies up to a not shown deactivation steering position. The steering wheel torque decreases rapidly at first and then moderately until steering is stopped 114.

The second hysteresis 12, shown with dashed lines, represents a course for higher steering speeds of the steering wheel, preferably steering speeds over about 200 degrees, for example. The maximum value of the steering wheel torque 200 is the same as for the hysteresis 11 for normal speeds. However, the virtual steering end stop position 120 is at a smaller steering wheel angle compared to the hysteresis 11 for normal speeds. The basic course is changed depending on the steering speed in that the activation position and the deactivation steering position of the feedback function of the virtual end stop also change. The hysteresis shape remains the same. Basically, the basic hysteresis curve in the diagram is shifted to the left for higher steering speeds of the steering wheel. The activation steering position is at a smaller steering wheel angle compared to the hysteresis 11 for normal speeds (not marked in FIG. 2). The same is true for the deactivation steering position.

Modification of the hysteresis curve based on steering speed is determined at the point of activation. This will guarantee that no torque fluctuation will occur due to steering speed change whilst the virtual end stop feedback function is active.

The third hysteresis 13, which is also shown with dashed lines, lies within the basic course of the first hysteresis 11. It represents small changes in steering direction, such as occur during parking maneuvers.

A steering direction is changed at 135 and steering wheel is turned backwards up to a second change in steering direction at 130. From there, the steering wheel is turned towards a virtual steering end stop position until the steering maneuver stops at 134.

The hysteresis curve 13 is based on the basic hysteresis curve 11 and the underlying look-up tables, which can be modified by further tunable parameters such as gain factors to yield the hysteresis curve 13. Such gain factors modify the basic steer-out and steer-in curves in order to connect them with each other. The basic shape of the third hysteresis 13 is derived from the steer-out function look-up table, but it is modified to generate more hysteresis (torque difference) between steer-out and steer-in.

The virtual steering end stop positions 112, 120 can be defined anywhere on the steering range. It can be set near or at the actual mechanical end stop or, in the event of a wheel blocking on a curb (curb block), much closer to the actual steering position. It is also possible that in the event of a wheel blocking on a curb, the virtual end stop feedback function is informed of this to activate feedback to the driver.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method to control a steer-by-wire steering system for a road vehicle, the steer-by-wire steering system including a steering wheel, a road wheel actuator to actuate road wheels, and a feedback actuator including mechanical end stops to apply a feedback torque to the steering wheel, a sensor to detect a steering wheel angle and a steering speed of the steering wheel, the method comprising:
a) providing a basic feedback torque;
b) when steering toward a mechanical end stop and the steering wheel angle is greater than or equal to an activation steering position:
i. activating a first virtual end stop feedback function, which determines a counter torque counteracting a driver's operation of the steering wheel, the first virtual end stop feedback function depending on the steering wheel angle and the steering speed;
ii. adding the counter torque to the basic feedback torque to yield a steering wheel torque, a course of the first virtual end stop feedback function being such that at a virtual steering end stop position a predefined maximum steering wheel torque is reached; and
iii. sending a resulting steering wheel torque to the feedback actuator and controlling the feedback actuator accordingly;
c) when steering backward from a mechanical end stop and the steering wheel angle is greater than or equal to a deactivation steering position:
i. activating a second virtual end stop feedback function to determine a counter torque counteracting a driver's operation of the steering wheel, the second virtual end stop feedback function depending on the steering wheel angle and the steering speed;
ii. adding the counter torque to the basic feedback torque to yield a steering wheel torque, a course of the second virtual end stop feedback function being such that at a virtual steering end stop position the predefined maximum steering wheel torque is reached; and
iii. sending a resulting steering wheel torque to the feedback actuator and controlling the feedback actuator accordingly.

2. The method according to claim 1, wherein the first and second virtual end stop feedback functions are based on look-up tables.

3. The method according to claim 1, wherein the counter torque provided by the first virtual end stop feedback function increases with increasing steering wheel angle.

4. The method according to claim 3, wherein the virtual end stop feedback functions are steering speed dependent, and upon activation of the respective virtual end stop feedback function the steering speed modification is determined.

5. The method according to claim 1, wherein the virtual steering end stop position is at a smaller steering wheel angle for higher steering speeds compared to lower steering speeds.

6. The method according to claim 1, wherein the virtual steering end stop position is less than or equal to the mechanical end stop position.

7. The method according to claim 4, wherein the virtual end stop feedback functions are modified by a gain factor during parking maneuvers.

8. The method according to claim 1, wherein the first and the second virtual end stop feedback functions have a same virtual steering end stop position.

9. The method according to claim 1, wherein, when a wheel blocks on a curb, the virtual steering end stop position is at or in a vicinity of the actual steering position.

10. The method according to claim 1, wherein the mechanical end stops are different, and the first virtual end stop feedback functions have a same absolute activation steering position and a same absolute virtual steering end stop position for same steering speeds.

11. A steer-by-wire steering system for a road vehicle configured or programmed to perform the method according to claim 1.
